(19) United States
(12) Patent Application Publication
(10) Pub. No.: US 2009/0260753 A1
(43) Pub. Date: Oct. 22, 2009

(54) Method for Production of an Optical Mirror

(75) Inventors: Martin Selig, Karlsruhe (DE); Max Mertins, Freiburg (DE)

Correspondence Address: COLLARD & ROE, P.C., 1077 NORTHERN BOULEVARD, ROSLYN, NY, 11576, US

(73) Assignee: NOVATEC BIOSOL AG, Karlsruhe (DE)

(21) Appl. No.: 11/991,974

(22) PCT Filed: Sep. 11, 2006
(86) PCT No.: PCT/DE2006/001596

§ 371 Date: Mar. 13, 2008

(30) Foreign Application Priority Data
Sep. 15, 2005 (DE) 10 2005 044 241.2
Feb. 9, 2006 (EP) 06002606.9

(51) Int. Cl. B32B 37/02

(52) U.S. Cl. 156/245

(57) ABSTRACT

In order to produce heliostats, which are used in solar-thermal power stations, the method according to the invention provides for a mirror plate (1) to be placed on a mount structure (2) using a required-shape mould (5) and with the interposition of adhesion means (6). The required-shape mould (5) and the position and orientation with respect to a defined reference point are in this case transferred to the mirror plate (1) and are modeled into the adhesive means (6). Once the adhesive means (6) have cured, the required-shape mould (5) is removed, after which its shape is embossed in the mirror plate (1).

The invention relates to a method for the production of an optical mirror, particularly for a solar collector, whereby a mirror pane that has a reflection side and an adhesive side is applied to a carrier construction.

This unit of mirror and carrier construction is referred to as a heliostat below.

Such concentrating solar collectors have already been known for a long time. Usually, they are produced in that a mirror film/foil is glued onto a carrier construction. Such a method is also described in DE 38 32 961 A1. In this connection, the invention was based on the task of finding a method by means of which it is made possible to glue together certain film/foil types that could not be glued together before.

This task is accomplished, according to the invention, in that the films/foils are first partially melted by means of heat effect, then provided with an adhesive, and finally brought into contact by pressing the film/foil surfaces together. The film/foil applied to a substrate in this manner, in a cut shape, is subsequently mounted on a carrier construction that is adapted to the requirements by way of a precision adjustment.

Solar thermal power plants usually work with a mirror assembly and a heat absorber, the so-called receiver. Here, one differentiates between systems that track on one axis or two axes. The heliostats of the heliostat field are guided with motors, in such a manner that incident sunlight is reflected and guided onto the receiver, which is situated elevated above the mirrors. In the case of a single-axis system, the receiver has one or more absorber tubes; in the case of a double-axis system, it has a pipe bundle or a volumetric absorber. The latter absorbs the solar radiation concentrated by means of the heliostats, and passes this energy on, converted into heat, using a medium that flows through. Over the course of the day, the heliostats are tracked to follow the sun, so that sunlight is always falling onto the receiver.

Among other things, such heliostats are produced in such a manner that their carrier construction corresponds to the reference shape of the mirror as precisely as possible, and the mirror itself is attached to this construction in such a manner that its reference shape occurs. The mirror pane itself is brought into the required shape, in the case of slight curvature, by means of elastic forcing, and in the case of larger curvatures, also by means of thermal deformation.

Correct guidance of the sunlight requires very great precision in the production of the heliostats used. The mirrors have a certain curvature, as a function of the distance from the receiver. In order to achieve the greatest possible yield, it is necessary for the curvature parameters of the mirror surface to be adhered to as precisely as possible. It is problematical, in this connection, that the production of such a precise mirror was only possible, up to the present, with very great effort, since the carrier construction already had to satisfy these precision requirements.

Therefore, the solution is known to produce a mirror having moderate precision, and to adjust this mirror precisely, by way of precision adjustment. This method sets great demands both on the material of the carrier construction, and on the technicians performing the precision adjustment.

It is necessary to define individual adjustable points on the carrier construction that can be fine-tuned by way of adjustment screws. The use of expert personnel is required for optimal adjustment of the collectors, and this causes high costs.

Particularly in times of rising energy costs, solar thermal power plants are developing into a worthwhile alternative for fossil fuels.

Therefore the invention is based on the task of making available a method for the production of an optical mirror, which method can do without precision adjustment of the mirrors after their production, without losses in accuracy, and allows mass production of such mirrors.

This task is accomplished using the method according to the characteristics of the main claim. Practical embodiments of this method can be derived from the dependent claims.

According to the invention, a mirror pane that was applied to a reference mold is used for the production of an optical mirror, particularly a heliostat for a concentrating solar collector. In this connection, the reflective side makes contact with the reference mold. The reference mold represents an impression of the ideal curvature for the mirror, in each instance, so that the mirror pane is also brought into its final shape, particularly into its final curvature, by means of its direct contact with the reference mold.

So that the mirrors of which the solar thermal power plant consists can track the sun, they are installed on carrier constructions that can be pivoted in such a manner that the greatest possible energy is always passed on to the receiver. The mirror pane is applied to the carrier construction with the interposition of adhesive. In this connection, the pane remains on the reference mold, so that it retains its ideal shape. The plastic adhesive connects the pane with the carrier construction, so that after the adhesive hardens, the pane is held in its actual position.

It has proven to be advantageous if the carrier construction is first provided with adhesive, and subsequently the mirror pane is pressed into the adhesive. The adhesive escapes, while the mirror pane is accommodated on the reference mold in close contact, and retains this shape due to the support from the reference mold. The mirror pane remains in this position with the reference mold at least until the adhesive has at least approximately hardened. After the reference mold is removed, the mirror pane still has the shape of the reference mold, which corresponds to the ideal curvature for the mirror, to the greatest possible extent.

An application of the adhesive, for example onto the carrier construction, does not have to take place over the full area. It is thus sufficient to apply the adhesive at individual support points and thus to hold the pane only at predetermined points. In this way, adhesive is saved, on the one hand, and the adhesive that escapes from the pressure of the mirror pane that is set on can then flow into the interstices between the support points.

Since a precision adjustment is not necessary, it is possible to use a rigid carrier construction for the assembly of the mirror pane. This carrier construction does not have to meet the high precision demands of the reference mold, by means of the method, since the tolerances are balanced out by the adhesive. Subsequent precision adjustment is also eliminated, according to the invention, and this represents an additional simplification of the construction and, at the same time, leads to cost savings in the production of the carrier constructions.

The strength of the mirror pane is additionally promoted in that the pane consists of a stiff but bendable material. If too soft a pane were used, it would not be possible to permanently avoid subsequent deformation, for example at locations of less support by means of support points.

In the following, the invention described above will be explained in greater detail using a drawing.

This shows:

FIG. 1 a carrier construction and a mirror pane drawn onto a reference mold, before assembly, in a sectional image representation,

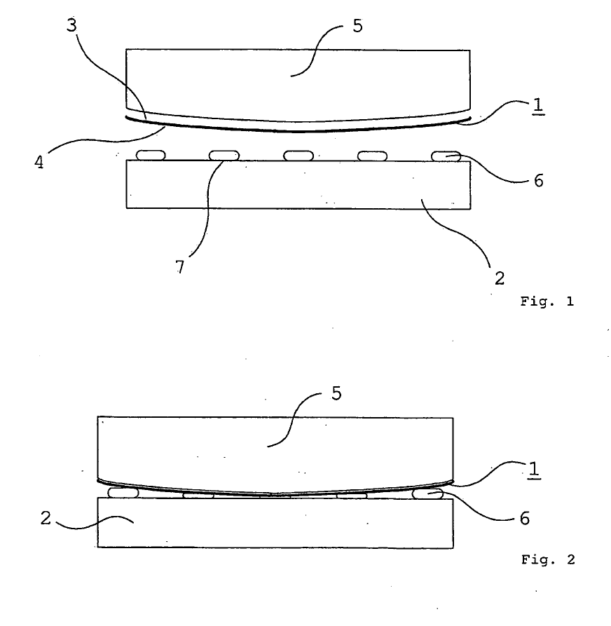

FIG. 2 a carrier construction with a mirror pane set on, whereby the reference mold has not been removed yet, in a sectional image representation, and

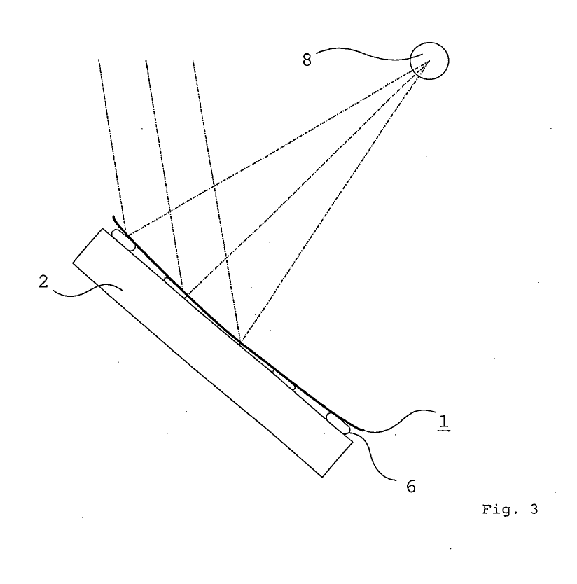

FIG. 3 a finished heliostat that is produced according to the method according to the invention, also in a sectional image representation.

FIG. 1 shows a carrier construction 2 for the production of a heliostat. Adhesive 6 is applied to the carrier construction 2 at individual support points 7. In advance of production, a mirror pane 1, which has a reflection side 3 and an adhesive side 4, was drawn onto a reference mold 5 in such a manner that the mirror pane 1 forms precisely the shape of the reference mold 5 on its reflection side 3. In the representation, the mirror pane 1 is shown at a slight distance from the reference mold 5, in order to guarantee clear labeling. In fact, however, the mirror pane 1 is drawn onto the reference mold 5 with tight contact.

FIG. 2 shows a second step of the production method, in which the mirror pane 1 together with the reference mold 5 is pressed into the adhesive 6. In this connection, the adhesive 6 escapes to the side, so that the shape of the mirror pane 1 is also transferred to the adhesive 6, in the final analysis. The reference mold 5 is left on the mirror pane 1 until the adhesive 6 has hardened and supports the shape of the mirror pane 1, on the one hand, and also holds it with its adhesive force, on the other hand. After hardening of the adhesive 6, the reference mold 5 can be removed, whereby the mirror pane 1 retains the curvature predetermined by the reference mold 5.

FIG. 3 shows the finished heliostat that guides the sunlight, drawn with a dot-dash line in the figure, onto the receiver. In this connection, this is only a fundamental representation, in which it must be taken into consideration that several such heliostats are assigned to a receiver 8. The carrier construction 2 can be pivoted, in a manner that is not of further interest here, so that the assembly can track the sunlight in such a manner that the maximal light yield is always passed to the receiver 8. The curvature of the mirror pane 1 is predetermined by its reference mold, as a function of the distance between heliostat and receiver 8.

Above, a method for the production of an optical mirror, particularly for a solar collector, is therefore described, which allows precise but nevertheless fast and simple production of such heliostats. This is achieved by means of the use of a reference mold onto which the mirror pane to be applied to the carrier construction is drawn. This pane, together with the reference mold, is applied to the carrier construction with the interposition of adhesive, and the mirror mold is only removed after the adhesive hardens, thereby preserving it.

### REFERENCE SYMBOL LIST

1 mirror pane
2 carrier construction
3 reflection side
4 adhesive side
5 reference mold
6 adhesive
7 support points

1: Method for the production of an optical mirror, particularly for a solar collector, whereby a mirror pane (1) that has a reflection side (3) and an adhesive side (4) is applied to a carrier construction (2), and the mirror sane (1) is drawn onto a reference mold (5) with its reflection side (3),
wherein subsequently, the mirror pane (1) together with the reference mold (5) is set onto the carrier construction (2), with its adhesive side (4), with the interposition of an adhesive (6), whereby the reference mold (5) is separated from the mirror pane (1) when the adhesive (6) has at least approximately hardened.

2: Method according to claim 1, wherein before assembly, the mirror pane (1) is accommodated on the reference mold (5) at least approximately with shape fit, the adhesive (6) is applied to the carrier construction (2), and the mirror pane (1) is pressed into the adhesive (6) with the adhesive side (4), over its full area, in such a manner that the reflection side (3) of the mirror pane (1) represents the surface of the reference mold (5) with at least approximate precision.

3: Method according to claim 2, wherein the adhesive (6) is applied to the carrier construction (2) only at individual support points (7).

4: Method according to claim 1, wherein a rigid construction is used as the carrier construction (2).

5: Method according to claim 1, wherein the mirror pane (1) consists of a stiff but bendable material.
